(19) United States
(12) Patent Application Publication
(10) Pub. No.: US 2024/0277052 A1
(43) Pub. Date: Aug. 22, 2024

(54) Aerosol Generating Device with a Vacuum Insulator

(71) Applicant: JT International SA, Geneva (CH)

(72) Inventor: Eduardo Jose Garcia Garcia, Grand-Saconnex (CH)

(73) Assignee: JT International SA, Geneva (CH)

(21) Appl. No.: 18/569,457

(22) PCT Filed: Jun. 23, 2022
(86) PCT No.: PCT/EP2022/067286

§ 371 Date: Dec. 12, 2023

(30) Foreign Application Priority Data
Jun. 28, 2021 (EP) 21182181.4

(51) Int. Cl. A24F 40/46; A24F 40/20; F16L 59/065

(52) U.S. Cl. CPC A24F 40/46; A24F 40/20; F16L 59/065

(57) ABSTRACT

An aerosol generating device includes a cavity in which an aerosol forming substance can be received; a heater configured to heat an aerosol forming substance received in the cavity; and a vacuum insulator provided around the heater, wherein an external surface of the vacuum insulator is an outer surface of the aerosol generating device that can be held by the user, in use.

### FIELD OF INVENTION

The invention relates to aerosol generating devices. In particular, the invention relates to aerosol generating devices with a vacuum insulator.

### BACKGROUND TO THE INVENTION

Aerosol generating devices are typically carried around by a user on their person on a day-to-day basis. There is therefore a demand for lighter and more compact aerosol generating devices. Additionally, it is desirable that aerosol generating devices can be made as efficient as possible, so that the battery life can be extended and thus the convenience for the user can be increased. It is an object of the present invention to address these competing demands.

### SUMMARY OF INVENTION

According to an aspect of the present invention, there is provided an aerosol generating device configured to generate an aerosol for inhalation by a user, comprising: a cavity in which an aerosol forming substance can be received; a heater configured to heat an aerosol forming substance received in the cavity; and a vacuum insulator provided around the heater, wherein an external surface of the vacuum insulator is an outer surface of the aerosol generating device that can be held by the user, in use.

In this way, the vacuum insulator can provide effective insulation for the heater to reduce the amount of heat that is lost to the environment. It has been found that the vacuum insulator can be at least partially exposed to the user without significantly compromising the ability of the vacuum insulator to insulate the heater efficiently. By having the external surface of the vacuum insulator as an outer surface of the aerosol generating device, the vacuum insulator can also act as an outer casing to protect and shield the internal components of the device from the user. In this way, the need to provide a full, separate outer casing is partially or entirely dispensed with, and thus an aerosol generating device can be provided which is both lighter and more compact. The vacuum insulator may be only partially exposed to the user, or in other words, the external surface of the vacuum insulator may be only partially an outer surface of the aerosol generating device. Alternatively, the external surface of the vacuum insulator may be fully exposed to the user so that the full external surface is an outer surface of the aerosol generating device.

In some embodiments, the aerosol generating device comprises an outer casing that partially encloses the vacuum insulator. In this way, the vacuum insulator can have an external surface which is an outer surface of the aerosol generating device and the device can be simple to manufacture and assemble. A partial enclosure of the vacuum insulator by the outer casing may increase the efficiency with which the heater is insulated. In one example embodiment, the vacuum insulator may be exposed to the external environment through a single, continuous gap or opening in the outer casing. In another example, the vacuum insulator may be exposed via a plurality of openings or gaps in the outer casing so that the external surface of the vacuum insulator is an outer surface of the aerosol generating device between the openings or gaps.

In other embodiments, the vacuum insulator may not be enclosed by the outer casing, but instead provided so that the external surface which is an outer surface of the aerosol generating device is externally flush with the outer casing.

Preferably, the external surface of the vacuum insulator is an outer surface of the aerosol generating device around a substantially full circumference of the aerosol generating device. In this way, the diameter of the aerosol generating device can be decreased along at least some cross sections of the device, and the device can be made both lighter and more compact.

Preferably, the external surface of the vacuum insulator is an outer surface of the aerosol generating device along a substantially full length of the aerosol generating device. In this way, the aerosol generating device can be provided with less outer casing and the device can be made both lighter and more compact.

Preferably, the vacuum insulator comprises metal. Metal vacuum insulators can be particularly efficient, and therefore use of a metal vacuum insulator can allow exposure of a greater proportion of the vacuum insulator to the user without compromising the efficiency of the aerosol generating device. In other embodiments, the vacuum insulator may comprise any suitable material as is known in the art.

Preferably, the aerosol generating device is configured to receive a consumable comprising tobacco within the cavity. The consumable may be in the form of a rod. The aerosol generating device may be a heat-not-burn device. When the consumable comprises tobacco, the provision of a vacuum insulator may be particularly important because of the high temperatures required to generate an aerosol from tobacco. In other embodiments, the aerosol generating device may be configured to receive a refillable or disposable cartridge containing an aerosol generating fluid.

Preferably, the vacuum insulator has an annular cylindrical shape. In this way, the vacuum insulator can surround the heater completely, thereby providing a more effective means of insulation.

### BRIEF DESCRIPTION OF THE DRAWINGS

Embodiments of the invention are now described, by way of example, with reference to the drawings, in which:

FIG. 1 is a cross-sectional schematic diagram of an aerosol generating device in an embodiment of the invention.

### DETAILED DESCRIPTION OF THE DRAWINGS

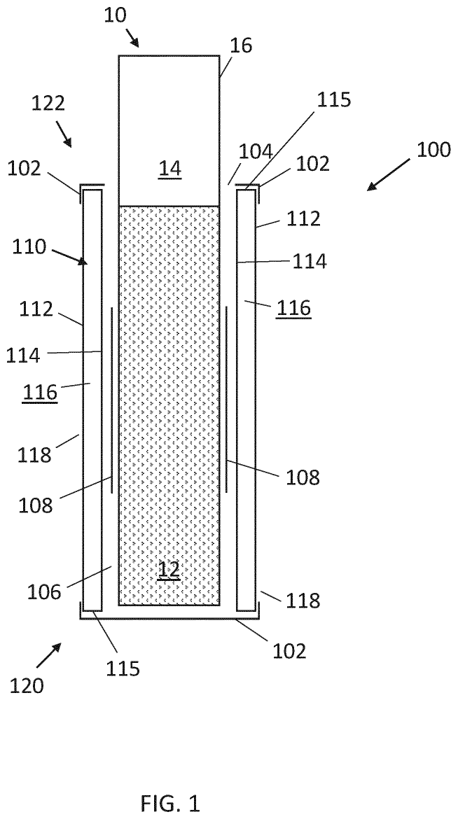

FIG. 1 is a cross-sectional schematic diagram of an aerosol generating device in an embodiment of the invention. An aerosol generating device 100 is provided and comprises an outer casing 102 for partially housing internal components of the aerosol generating device 100. The outer casing 102 comprises an opening 104 to a cavity 106 configured to receive a consumable 10. The consumable 10 comprises tobacco 12 and a filter 14, both of which may be held together by a tipping wrapper 16. A heater 108 is provided within the cavity 106 and is configured to provide heating to the consumable 10 when received within the cavity 106 to generate an aerosol. A vacuum insulator 110 is provided surrounding the heater 108 and has an annularly cylindrical shape with an external surface 112 and internal surface 114, between which a vacuum 116 is enclosed. The outer casing 102 comprises an opening 118 that extends along a substantially full length of the aerosol generating device and around its full circumference. The opening 118 partially exposes the external surface 112 to the user, so that the external surface 112 of the vacuum insulator 110 is an outer surface of the aerosol generating device 100. The aerosol generating device 100 also comprises a controller (not shown) for controlling operations of the aerosol generating device 100, a button (not shown) for receiving instructions from a user, an air inlet (not shown) in fluid communication with the cavity 106, and a battery (not shown) to power the aerosol generating device 100. The controller and battery are in electric communication with the button and heater 108 via wires.

The outer casing 102 may comprise any suitable material as is known in the art. The aerosol generating device 100 is elongate along a longitudinal direction, and the cavity 106 is elongate along the longitudinal direction.

In the embodiment of FIG. 1, the heater 108 is provided as a film heater that is resistively or inductively heatable. In alternative embodiments, the heater 108 may be provided as any suitable heater that can heat the consumable 10 within the cavity 106 to generate an aerosol. The heater 108 may be provided at a periphery of the cavity 106 as one or more curved heating films that extend around a substantially full circumference of the cavity 106. Alternatively, the heater 108 may be provided as one or more substantially flat heating films or plates provided at spaced positions around a periphery of the cavity 106. The heater 108 may be configured to contact with the consumable 10 received within the cavity 106, so that the consumable 10 is held within the cavity 106 by friction against the heater 108. The heater 108 may be fixed to the internal surface 114 of the vacuum insulator 110 by one or more mechanical couplings. Alternatively, the heater 108 may be held within the cavity 106 by a support structure attached to the outer housing 102.

In other embodiments, the cavity 106 and the heater 108 may be configured to receive and heat, respectively, other forms of consumables as is known in the art. For example, the cavity 106 may be configured to receive a consumable cartridge comprising a reservoir containing an aerosol generating fluid, and the heater 108 may be configured to provide heating to the consumable when received in the cavity 106. In such cases, the vacuum insulator 110 and cavity 106 may be shaped appropriately so that the cartridge can be received within the cavity 106 to be heated by the heater 108 and insulated by the vacuum insulator 110.

The vacuum insulator 110 has an annularly cylindrical shape with a circular cross-section. The vacuum insulator 110 is hollow and encloses a vacuum 116 between a curved internal surface 114, a curved external surface 112, and two flat surfaces 115 that connect the internal surface 114 and the external surface 112. In other embodiments, the vacuum insulator 110 may have other shapes. For example, the vacuum insulator 110 may have a square or polygonal cross-section. In other embodiments, the vacuum insulator 110 may be provided as two or more vacuum insulators, for example semi-circular or flat vacuum insulators, provided around the heater 108. In such embodiments, the two or more vacuum insulators may surround and insulate the heater 108 collectively.

As shown in FIG. 1 towards a first end 120 and a second end 122 of the aerosol generating device 100, the vacuum insulator 110 is partially enclosed by the outer casing 102, which partially covers the external surface 112 of the vacuum insulator 110. The vacuum insulator 110 may be mechanically attached to the outer casing 102 by one or more mechanical couplings. The vacuum insulator 110 may be a high-performance metal vacuum insulator. In other embodiments, the vacuum insulator 110 may comprise other suitable materials.

The opening 118 of the outer casing 102 extends along a substantially full longitudinal length and around a full external circumference of the aerosol generating device 100. In other example embodiments, the opening 118 may be smaller so that less of the external surface 112 of the vacuum insulator 110 is exposed and visible to the user. Alternatively, the outer casing 102 may comprise a plurality of openings through which the external surface 112 of the vacuum insulator 110 is visible and exposed to the user.

The controller may be housed within the outer casing 102 and comprises a memory and a processor for storing and executing instructions to control various operations of the aerosol generating device 100. The air inlet may be provided as an opening in the outer casing 102 towards the first end 120 of the aerosol generating device 100 to enable the user to draw air through the cavity 106 via the filter 14. The button may also be provided on an external surface of the outer casing 102 for receiving an input from the user. Alternatively, any other input mechanism, such as a fingerprint sensor, may be provided for receiving an input from the user.

An example use of the aerosol generating device 100 will now be described with reference to FIG. 1. In use, a user can insert the consumable 10 through the opening 104 into the cavity 106. The heater 108 holds the consumable 10 in place within the cavity 106 by friction. This contact between the heater 108 and the consumable 10 also increases the efficiency with which heat is delivered to the tobacco 12 within the consumable 10. When the user is ready to initiate vaporisation, the user may press the button, which in turn triggers the controller to turn on the heater 108. The heater 108 provides heating to the air and tobacco 12 within the cavity 106, while the vacuum 116 within the vacuum insulator 110 drastically inhibits the escape of heat from the cavity 106 by conduction and convection. Thus, the cavity 106, the heater 108, and the vacuum insulator 110 form an oven in which the tobacco 12 within the consumable 10 can be heated to a desired temperature. The controller may be configured to instruct the heater 108 to heat the tobacco to temperatures below the combustion temperature of tobacco. As the tobacco 12 is heated, an aerosol is produced inside the cavity 106. The user can inhale the aerosol by drawing air through the air inlet via the filter 14 to generate an airflow through the cavity 106 which carries the aerosol to the user.

The external surface 112 of the vacuum insulator 110 is exposed to the user via the opening 118 so that the external surface 112 is an outer surface of the aerosol generating device 100 that can be held by the user, in use. Thus, the aerosol generating device 100 is both lighter and more compact than would be the case if the outer casing 102 completely covered the external surface 112. The vacuum insulator 110 provides sufficient insulation to the heater 108 and the heated air inside the cavity 106 such that the efficiency of the aerosol generating device 100 is not significantly impacted by the opening 118. The opening 118 extends along a substantially full length and around a full circumference of the aerosol generating device 100, thus reducing the diameter of the aerosol generating device 100. This makes the aerosol generating device 100 more convenient for the user to store and carry.

1. An aerosol generating device configured to generate an aerosol for inhalation by a user, comprising:
a cavity in which an aerosol forming substance can be received;
a heater configured to heat an aerosol forming substance received in the cavity; and
a vacuum insulator provided around the heater, wherein an external surface of the vacuum insulator is an outer surface of the aerosol generating device that can be held by the user, in use.

2. The aerosol generating device of claim 1, further comprising an outer casing that partially encloses the vacuum insulator.

3. The aerosol generating device of claim 1, wherein the external surface of the vacuum insulator is an outer surface of the aerosol generating device around a substantially full circumference of the aerosol generating device.

4. The aerosol generating device of claim 1, wherein the external surface of the vacuum insulator is an outer surface of the aerosol generating device along a substantially full length of the aerosol generating device.

5. The aerosol generating device of claim 1, wherein the vacuum insulator comprises metal.

6. The aerosol generating device of claim 1, configured to receive a consumable comprising tobacco within the cavity.

7. The aerosol generating device of claim 1, wherein the vacuum insulator has an annular cylindrical shape.
